(19) United States
(12) Patent Application Publication
(10) Pub. No.: US 2012/0114984 A1
(43) Pub. Date: May 10, 2012

(54) BATTERY MODULE

(76) Inventors: Myung-chul Kim, Yongin-si (KR); Hyun-Ye Lee, Yongin-si (KR); Hee-Joon Jin, Yongin-si (KR)

(21) Appl. No.: 13/239,227

(22) Filed: Sep. 21, 2011

(30) Foreign Application Priority Data
Nov. 4, 2010 (KR) 10-2010-0109181

(51) Int. Cl. H01M 2/12

(52) U.S. Cl. 429/53

(57) ABSTRACT

A battery module includes a battery array having a plurality of battery cells each including a terminal surface exposing an electrode terminal and a vent, and a bottom surface generally opposite to the terminal surface, wherein the battery cells are stacked together; end plates adjacent outer ends of the battery array and having electrode openings exposing the electrode terminals; vertical fixing plates having side holders extending along a portion of a side of the battery array; and horizontal insulating members located between adjacent ones of the stacked battery cells.

### CROSS-REFERENCE TO RELATED APPLICATION

This application claims priority to and the benefit of Korean Patent Application No. 10-2010-0109181, filed on Nov. 4, 2010, in the Korean Intellectual Property Office, the entire content of which is incorporated herein by reference.

### BACKGROUND

1. Field

The present invention relates to a battery module.

2. Description of Related Art

In general, secondary batteries can be reused by discharging and recharging, unlike primary batteries that can not be recharged. The secondary batteries are used as energy sources for mobile devices, electric vehicles, hybrid vehicles, electric bicycles, and uninterrruptible power supplies, and may be used in a single battery type or a battery module type composed of a plurality of batteries connected in one unit, in accordance with various available external devices.

Although small mobile devices, such as mobile phones, can operate for some time with the output and capacity of a single battery, electric modules having larger output and capacity are often more suitable to operate electric vehicles and hybrid vehicles with high power for a long time because such vehicles consume a large amount of electricity. The battery modules are used by connecting a required number of batteries in parallel or series in accordance with output and capacity.

### SUMMARY

In one embodiment, a battery module is provided that does not need specific side fixing members. Further, in another embodiment, a battery module is provided having a structure that can effectively discharge heat generated from battery cells while maintaining sufficient strength for fixing a battery array.

In one embodiment, a battery module is provided including a battery array having a plurality of battery cells each including a terminal surface exposing an electrode terminal and a vent, and a bottom surface generally opposite to the terminal surface, wherein the battery cells are stacked together; end plates adjacent outer ends of the battery array and having electrode openings exposing the electrode terminals; vertical fixing plates having side holders extending along a portion of a side of the battery array; and horizontal insulating members located between adjacent ones of the stacked battery cells.

In one embodiment, the battery array includes a pair of battery cells stacked together such that each of the bottom surfaces face each other, wherein a plurality of the pair of battery cells are stacked together such that side surfaces of the battery cells face each other, wherein one of the end plates contacts the terminal surface of at least one of the battery cells, and wherein the vertical fixing plates extend between and are coupled to each of the end plates.

Further, a vertical insulating member may located between the bottom surface of adjacent ones of the battery cells. In one embodiment, the vertical insulating member is a plastic H-beam and is fixed to the vertical fixing plates. In one embodiment, the vertical fixing plates have ridges, wherein the ridges are recessed from the vertical fixing plate in a longitudinal direction of the vertical fixing plate.

Additionally, in one embodiment, the vertical fixing plates have a notch on a edge thereof and wherein the end plate has a body and an extending portion extending at an angle from an edge of the body and fastening through-holes on the extending portion, the fastening through holes being adjacent to the notch. Further, the vertical fixing plate may include a reinforcing wall extending between the side holders.

The battery module according to embodiments of the present invention can fix the battery arrays without specific side fixing members. Further, according to embodiments of the present invention, it is possible to fix the battery array with sufficient strength and effectively discharge the heat produced from the battery cells.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a perspective view showing an example of a transverse type of battery module.

FIG. 2 is a schematic exploded perspective view of the battery module shown in FIG. 1.

FIG. 3A is a perspective view showing a vertical fixing plate according to an embodiment.

FIG. 3B is a front view showing the vertical fixing plate shown in FIG. 3A.

FIG. 4A is a perspective view showing a vertical fixing plate according to another embodiment.

FIG. 4B is a front view showing the vertical fixing plate shown in FIG. 4A.

FIG. 5 is a perspective view showing a vertical fixing plate with heat dissipation holes.

FIG. 6 is a perspective view showing an upper fixing plate with cut-off portions.

FIG. 7 is a bottom perspective view showing a vertical fixing plate with reinforcing portions.

FIG. 8A is a perspective view showing a vertical insulating member according to an embodiment.

FIG. 8B is a transverse cross-sectional view showing the vertical insulating member of FIG. 8A.

FIG. 9 is a perspective view showing an example of a battery module with an exemplary vertical fixing plate.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements.

Hereinafter, exemplary embodiments of the present invention will be described with reference to the accompanying drawings. The terms representing directions, such as “up, down, left, right” used herein are considered to be based on the status shown in the drawings, if not specifically defined or stated. Further, the same reference numerals represent the same parts throughout the embodiments.

Meanwhile, the arrangement of battery cells and the stacked structure are defined as a battery array hereafter.

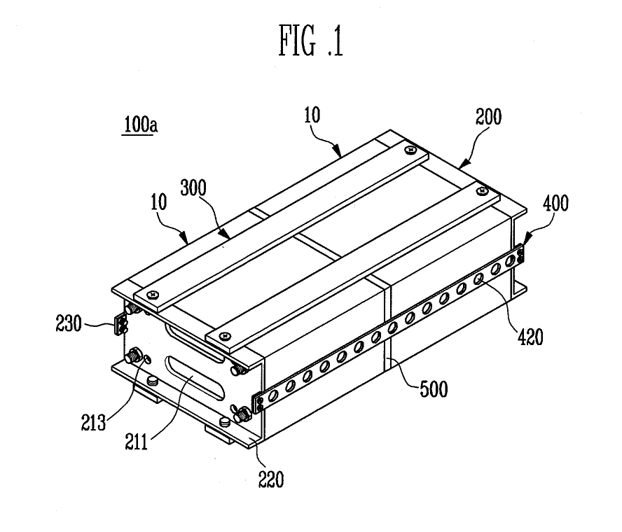

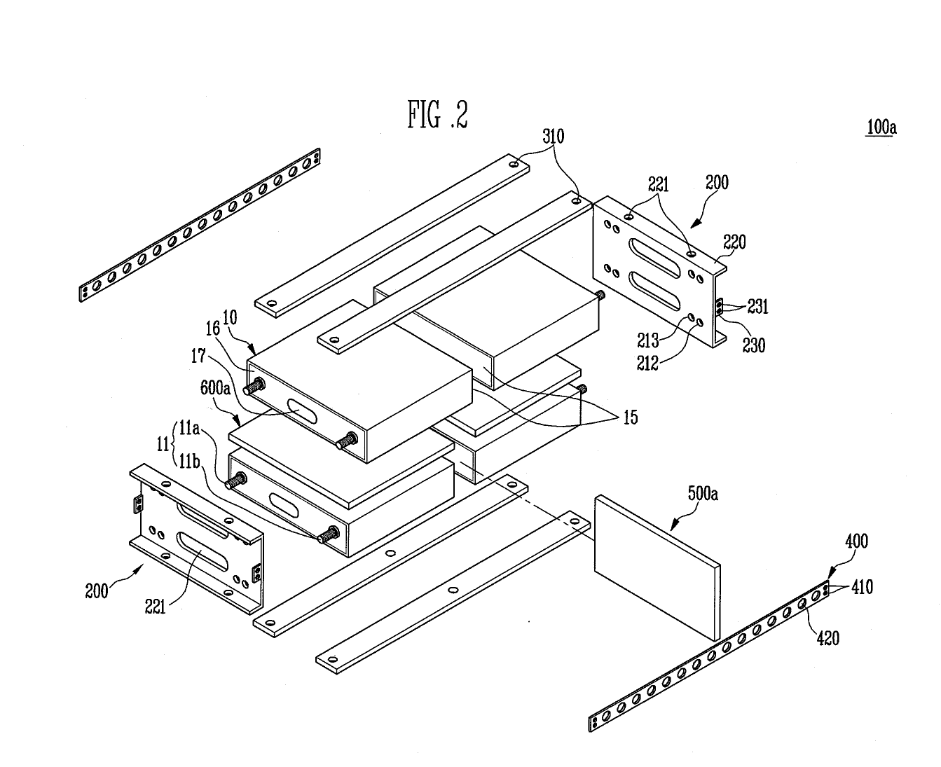

The type of a battery module 100a where the present invention is applied is described with reference to FIGS. 1 and 2. FIG. 1 is a perspective view showing an example of a transverse type of battery module and FIG. 2 is an exploded perspective view of the battery module shown in FIG. 1.

The present invention can be applied to the transverse type of battery module 100a shown in FIG. 1. The transverse type of battery module 100a may include a plurality of battery cells 10 forming a battery array, a configuration for insulating, and a configuration for fixing.

In one embodiment, the battery cells 10 are generally formed in hexahedral shapes. A terminal surface 11 is provided to support both electrode terminals (an anode terminal 11b and a cathode terminal 11a) and a vent 17. The vent 17 is formed at the center of the terminal surface 16. The vent 17 allows a gas produced in the battery cell 10 to be discharged. The electrode terminals 11 are formed on either side of the vent 17. Both electrode terminals 11 function as a path allowing the current produced in the battery cell 10 to flow to the outside. Further, the opposite side to the terminal surface 11 is referred to as a bottom surface 15 hereafter.

The battery cells 10 are transversely oriented such that the bottom surfaces 15 of two battery cells 10 face each other. The electrode terminals 11 are oriented to face the outside of the battery array. The pair of battery cells 10 oriented as described above are stacked in two or more layers, as shown in FIG. 2. The electrode terminals 11 of the upper and lower stacked battery cells 10 may have the same polarity or opposite polarities. As shown in FIG. 2, two opposite battery cells may be provided in one layer, but single cells 10 may be stacked. Further, embodiments of the present invention may be applied when the number of stacked battery cells 10 is two or more, but is not limited thereto.

Fixing members are provided, which may include upper and lower fixing members 300, side fixing members 400, and end plates 200. The end plates 200 are fastened to the terminal surfaces 16 at both ends of the battery array 10 such that the electrode terminals 11 and the vent hole 17 are exposed to the outside. In one embodiment, the upper and lower fixing members 300 are located on and under the battery array 10. Specifically, the upper and lower fixing members 300 may be fixed to the top and the bottom of the end plates 200 as shown for example in FIG. 2 to restrict vertical movement of the battery array 10. The side fixing members 400 are located on the sides of the battery array 10. In one embodiment, the side fixing members 400 are fixed to both sides of the end plates 200 to restrict side movement of the battery array 10.

A vertical insulating member 500a and a horizontal insulating member 600a may be provided as insulating members. The vertical insulating member 500a is located between the bottom surfaces 15 of two opposite battery cells 10 for insulation and the horizontal insulating member 600a is located between two stacked battery cells 10 for insulation.

Embodiments of the present invention relate to a configuration corresponding to the vertical fixing plate 300 as described in detail below.

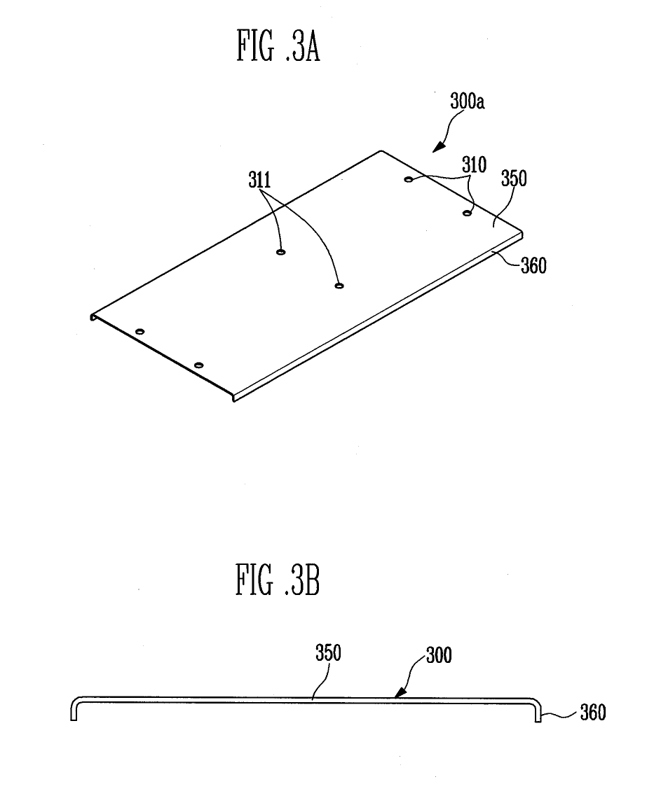

A vertical fixing plate 300 with holders is described with reference to FIGS. 3A and 3B. FIG. 3A is a perspective view showing a vertical fixing plate according to an embodiment. FIG. 3B is a front view showing the vertical fixing plate shown in FIG. 3A.

The vertical fixing plate 300a has holders 360 vertically extending from the outsides of both sides of a body 350. Although it is possible to reduce weight by cutting off a portion of the holders 360, when the holders 360 replace the side fixing members, it is advantageous in strength not to cut off the holders 360. The holders 360, as described above, contact with and hold the sides of the battery cell fixed by the upper and lower plates 300a.

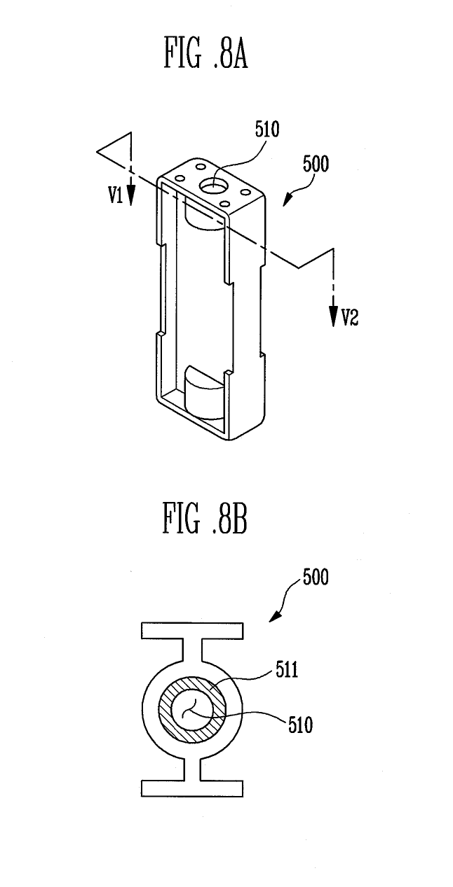

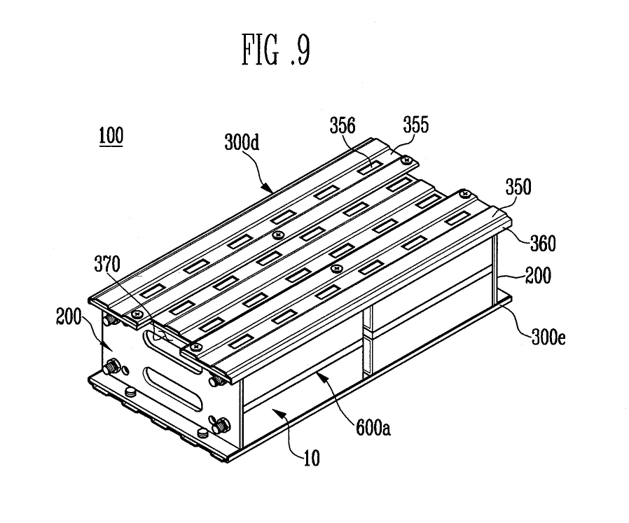

Further, through-holes 310 are formed at both ends of the body 350 and through-holes 311 for fastening to the vertical insulating member 500 (see FIG. 8A), which is described below, are formed at the center of the body 350.

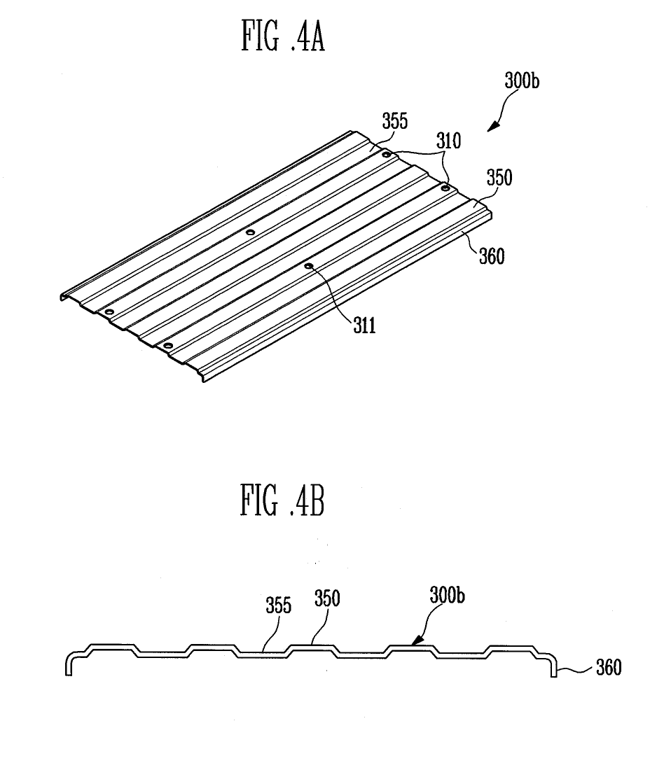

A vertical fixing plate 300b with ridges is described with reference to FIGS. 4A and 4B. FIG. 4A is a perspective view showing a vertical fixing plate according to another embodiment. FIG. 4B is a front view showing the vertical fixing plate shown in FIG. 4A.

The vertical fixing plate 300b may have ridges 335 recessed from the body 350 and extending in the longitudinal direction. As shown in FIG. 4B, a plurality of ridges 355 depressed on the body 350 are formed, such that the strength against bending of the body 350 is increased.

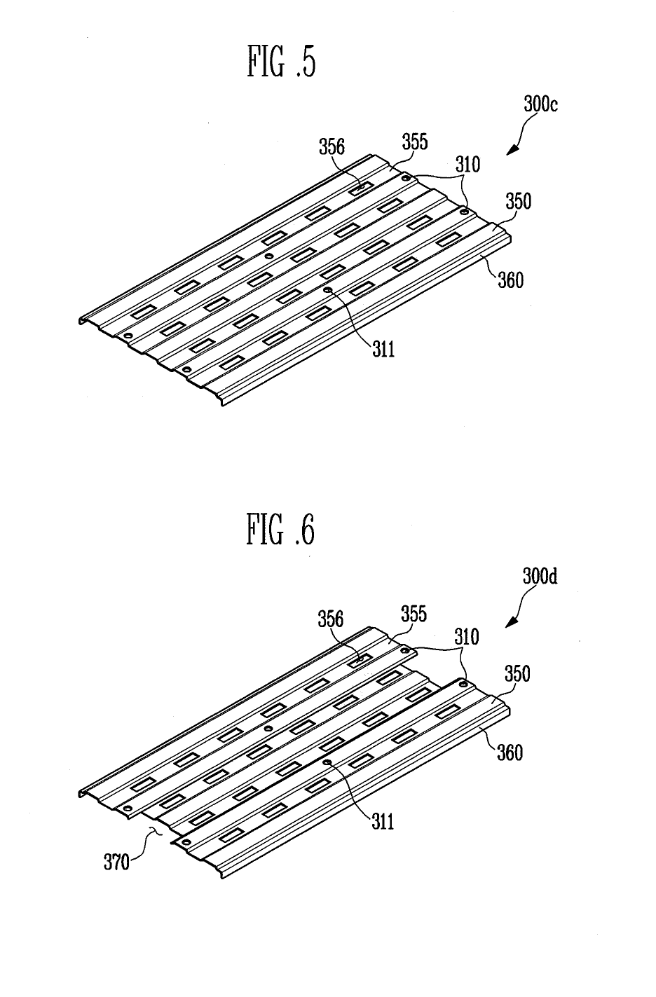

A vertical fixing plate with heat dissipation holes is described with reference to FIG. 5 which is a perspective view showing a vertical fixing plate with heat dissipation holes.

In one embodiment, heat dissipation holes 356 may be formed in a vertical plate 300c. The heat dissipation holes 356 function as paths for discharging internal heat produced in the battery cells to the outside. Further, because the internal heat is usually produced around the battery cells, the heat dissipation holes 356 may be located to generally correspond to the battery cells when a battery module is formed. The heat dissipation holes 356 may be formed on the body 350 or on the ridges 355 and the appropriate number is determined with respect to the desired strength of the vertical plate 300c.

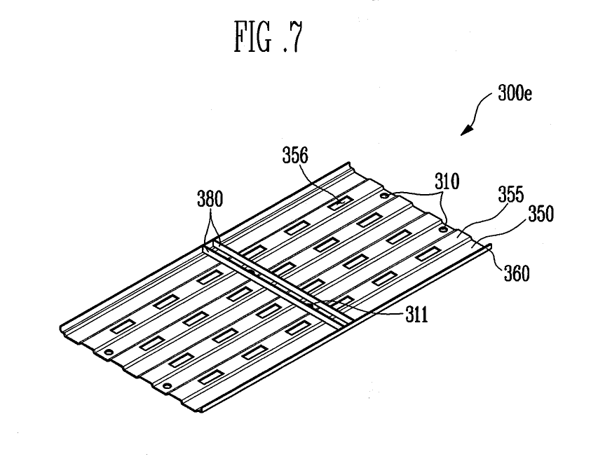

A vertical fixing plate 300d with cut-off portions or notches is described with reference to FIG. 6, which illustrates a perspective view showing an upper fixing plate with cut-off portions.

Cut-off portions 370 are formed at generally the center portions of both ends of the upper fixing plate 300d. As shown in the figure, the cut-off portions are portions which are recessed from the fixing plate 300d. In one embodiment, a tool is used in the cut-off portions 370 in order to assemble one battery module by combining the components described above or to fix the combined battery modules to an object, such as an electric vehicle. In particular, it may be difficult to fix the battery module in an electric vehicle requiring large capacity and/or high output because the space for the battery module is small. The fixing work can be more easily performed with the inclusion of the cut-off portions 370.

A vertical fixing plate 300e with reinforcing portions is described with reference to FIG. 7 which illustrates a bottom perspective view showing a vertical fixing plate with reinforcing portions.

As shown in FIG. 7, reinforcing portions 380 may be located on the inner side of the vertical fixing plate 300e and extend across the plate. The reinforcing portions 380 are connected to holders 380 at both sides, thereby increasing the structural strength of the fixing plate 300e. The reinforcing portions 380 may be formed anywhere on the vertical fixing plate 300e, and in one embodiment are formed on both sides of a fastening through-hole 311 at the center of the vertical fixing plate 300e to avoid interfering with the battery cells during assembly of a battery module.

A vertical insulating member is described with reference to FIGS. 8A and 8B. FIG. 8A is a perspective view showing a vertical insulating member according to an embodiment and FIG. 8B is a horizontal cross-sectional view of the vertical insulating member of FIG. 8A.

As shown in FIG. 2, the vertical insulating member is located between the bottom surfaces 15 of the battery array for insulation.

The vertical insulating member 500 may be used to insulate the bottom surfaces 15 of the battery cells 10, for example in a plate shape as described above, regardless of the shape of the battery cells. Often, the battery cells 10 expand slightly when being repeatedly charged and discharged. According to an embodiment of a battery module, since the distance between both terminal surfaces 16 of battery cells 10 in one array is relatively large, the vertical fixing member 300a may not sufficiently compress the battery cells 10 together. The vertical insulating member 500 may be an H-beam (i.e., a cross-section of the insulating member 500 is generally H-shaped) shown in FIGS. 11A and 11B. Thread-fastening portions 510 may be formed at the upper and lower ends of the H-beam to be connected with the vertical fixing plate 300a. A metal layer 511 may be further formed by double injection molding to reinforce the strength of the thread-fastening portions 510. The thread-fastening portion 510 and the second through-hole 311 described above are coupled by a bolt in assembling this embodiment.

An example of a battery module with a vertical plate is described with reference to FIG. 9 which illustrates a perspective view of an exemplary battery module with a vertical fixing plate.

As described above, the vertical fixing plate 300d is located on the battery module 100 and fixed to the end plates 200 at both ends. Further, the lower fixing plate 300e is located under the battery module 100 and fixed to the end plates 200 at both ends. The upper and lower fixing plates 300d, 300e restrict side movement in addition to vertical movement of the battery array 10. Further, the heat produced from the battery cells 10 can be easily discharged through the heat dissipation holes 356, even after the battery cells 10 stop operating.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A battery module comprising:
a battery array comprising a plurality of battery cells each including a terminal surface exposing an electrode terminal and a vent, and a bottom surface generally opposite to the terminal surface, wherein the battery cells are stacked together;
end plates adjacent outer ends of the battery array and having electrode openings exposing the electrode terminals;
vertical fixing plates having side holders extending along a portion of a side of the battery array; and
horizontal insulating members located between adjacent ones of the stacked battery cells.

2. The battery module according to claim 1, wherein the battery array comprises a pair of battery cells stacked together such that each of the bottom surfaces face each other,
wherein a plurality of the pair of battery cells are stacked together such that side surfaces of the battery cells face each other,
wherein one of the end plates contacts the terminal surface of at least one of the battery cells, and
wherein the vertical fixing plates extend between and are coupled to each of the end plates.

3. The battery module according to claim 2, wherein a vertical insulating member is located between the bottom surface of adjacent ones of the battery cells.

4. The battery module according to claim 3, wherein the vertical insulating member is a plastic H-beam.

5. The battery module according to claim 3, wherein the vertical insulating member is fixed to the vertical fixing plates.

6. The battery module according to claim 5, further comprising a plurality of vertical insulating members.

7. The battery module according to claim 1, wherein the vertical fixing plates have ridges.

8. The battery module according to claim 7, wherein the ridges are recessed from the vertical fixing plate in a longitudinal direction of the vertical fixing plate.

9. The battery module according to claim 1, wherein the vertical fixing plates have heat dissipation holes extending therethrough.

10. The battery module according to claim 9, wherein the heat dissipation holes are located to generally correspond to an adjacent battery cell,

11. The battery module according to claim 1, wherein the vertical fixing plates have a notch on a edge thereof and wherein the end plate has a body and an extending portion extending at an angle from an edge of the body and fastening through-holes on the extending portion, the fastening through holes being adjacent to the notch.

12. The battery module according to claim 1, wherein the vertical fixing plate comprises a reinforcing wall extending between the side holders.
